(19) United States
(12) Patent Application Publication
(10) Pub. No.: US 2015/0332294 A1
(43) Pub. Date: Nov. 19, 2015

(54) Method and system for profiling and scheduling of thermal residential energy use for demand-side management programs

(71) Applicant: The Board of Trustees of the Leland Stanford Junior University, Palo Alto, CA (US)

(72) Inventors: Adrian Albert, San Francisco, CA (US); Ram Rajagopal, Palo Alto, CA (US)

(21) Appl. No.: 14/716,763

(22) Filed: May 19, 2015

Related U.S. Application Data
(60) Provisional application No. 62/000,290, filed on May 19, 2014.

(51) Int. Cl. G06Q 30/02

(52) U.S. Cl. CPC G06Q 30/0202

(57) ABSTRACT

A methodology is provided for informing targeted Demand-Response (DR) and marketing programs that focus on the temperature-sensitive part of residential electricity demand. The methodology uses energy consumption readings collected from “smart” electricity meters, as well as hourly temperature readings. Individual consumption is decomposed into a thermal-sensitive part and a base load (non thermally-sensitive), a model of temperature response that is based on thermal regimes, i.e., unobserved decisions of customers to use their heating or cooling appliances. This model is used to extract useful benchmarks that compose a thermal profiles of individual customers, i.e., terse characterizations of the statistics of these customers' temperature-sensitive consumption. This knowledge may, in turn, inform the DR program by allowing scarce operational and marketing budgets to be spent on customers whose influencing will yield highest energy reductions at the right time. Methods are also provided for scheduling optimal, individual customer controls of the thermal appliance to achieve a desired profile of the aggregate energy reductions.

### CROSS-REFERENCE TO RELATED APPLICATIONS

This application claims priority from U.S. Provisional Patent Application 62/000,290 filed May 19, 2014, which is incorporated herein by reference.

### STATEMENT OF GOVERNMENT SPONSORED SUPPORT

This invention was made with Government support under contract no. DE-AR0000018 awarded by the Department of Energy. The Government has certain rights in the invention.

### FIELD OF THE INVENTION

The present invention relates generally to techniques for utility energy use monitoring, analysis, and prediction, with applications to energy conservation.

### BACKGROUND OF THE INVENTION

In recent years, energy utility companies have rolled out advanced sensing infrastructure to better meter energy consumption and inform demand management practices such as Demand-Response. Millions of smart meters deployed in California, for example, are collecting hourly or sub-hourly energy consumption data. Yet, it remains a challenge to extract useful information from this wealth of data, especially in cases where there is no information regarding the physical parameters of utility customer homes or the specific appliances in use. Moreover, utility companies need to make operational decisions based on smart meter and other data, while at the same time preserving the privacy of their customers.

### SUMMARY OF THE INVENTION

In the particular context of demand-side management programs, this invention provides methods in which actionable information allows accurate ranking and comparison between customers, as well as prescribing specific actions that customers may take that would be beneficial for the system as a whole. In one aspect, the present invention provides a methodology that connects consumption data from smart meters and time series of related factors to decisions that utility customers make to use certain appliances. Such factors relevant in the smart grid demand management context may be weather (temperature, ambient lighting, etc.) and time-of-day, day-of-week, real-time prices, among others. By inferring and anticipating customer decisions non-intrusively, utility companies and other providers of smart grid services may create tailored automated controls and tailored marketing communications and requests to the different types of customers in their portfolio.

In preferred embodiments the thermal profiling model building methodology includes three general steps: 1) learning a statistical model of customer response to external factors; 2) decoding customer decisions given historical data on consumption, and 3) filtering and interpreting the obtained model parameters.

In a specific embodiment of the invention, the set of thermal profile models that are learned for each individual customer may be used for a variety of applications, including but not limited to 1) the specific problem of inferring the rate of variation with temperature of the usage of electricity-powered HVAC appliances given (external) temperature data; 2) comparing and ranking customers at different temperature levels according to the aforementioned rate of change of thermal energy use with a change in temperature, and 3) scheduling optimal customer actions or controls for a demand-response program that requires changing the operating setpoint of the thermal appliance.

The thermal profiling methodology allows characterizing the thermal and non-thermal components of energy consumption for individual residential customers using smart meter and weather time series data. This statistical description of thermal response allows comparison between customers for the purpose of Demand-Response program selection and signal dispatch control scheduling.

The model used in preferred embodiments of the thermal profiling system makes use of identified “regimes” in consumption that are characterized by a small set of parameters—e.g., base consumption, response to weather and/or other covariates, and consumption volatility (which is an indicator of customer occupancy of the premise). Consumption is viewed as resulting from the sequence of such regimes over time, a process which is governed by potentially other external covariates. The thermal regimes model that describes consumption as a dynamic decision process is a significant feature, as is the consumption model interpretation mechanism.

Input data to the thermal profiling system includes hourly or sub-hourly consumption (smart meter) readings and weather (temperature and other covariates) data from a large number of individuals. A dynamic structural model uses hourly electricity and weather (temperature) readings to characterize residential customers' thermally-sensitive consumption. The model assumes that consumption is the observable outcome of latent, temperature-dependent decisions of customers on whether to heat, cool, or not to use HVAC at all. In effect, the model performs a coarse decomposition of a customer's consumption into a base load (assumed non-controllable), and a thermal response load (assumed controllable through either customer actions or automated control signals from the utility that affect HVAC operation settings). From this model useful benchmarks are extracted to build profiles of individual customers for use with thermal (heating or cooling) DR programs.

Mathematically, this model may be expressed as a non-homogeneous hidden-Markov process between a small number of states, here referred to as “thermal regimes”. Such models have two main components: a state-specific emission process (which gives rise to the observed data), and a state transition process. Both processes have means that depend linearly on the external temperature. Model estimation is done either through an Expectation-Maximization approach (in a variation of the Baum-Welch algorithm that is in wide use for estimating the parameters of hidden Markov models), or through direct likelihood maximization with linear constraints. Also provided is a methodology for estimating the number of states from the data.

A significant feature of the method is that it internalizes explicitly other sources of data that consumption may depend on. This occurs at both components of the Hidden Markov Model, i.e., the state transition matrix and the observation emission distributions. Since the method incorporates such data through state-specific regression models, it can compute linear rates of change of observed consumption to variables of interest, as well as rates of change of probability in thermal usage based on changes in these additional variables.

Additionally, the method does not rely on building a physical model of the thermostatically controlled loads (TCLs). This is also a consequence of using hourly data, which has less resolution for capturing the on-off behavior of a TCL (the typical cycle of a TCL is on the order of 5 minutes). Instead, consumption is described as the result of a decision process of whether to consume HVAC or not, which provides a framework for averaging across multiple on/off events of a TCL that are not captured when available data is at the hourly or 15-minute level.

The framework is used explicitly to compute rates of change in consumption at a given level of temperature (or of other external covariates), as opposed to disaggregating absolute values of thermal consumption from non-thermal consumption. This is to estimate flexibility to a specific action in a dynamic fashion, and to compare this flexibility across customers. For example, in an application to scheduling thermostat setting actions, it can estimate an action for the change of the thermostat setting by a set quantity. As such, the model can be used in an operational setting to estimate what efficiencies might be achieved in a demand-side management (DSM) for a realistic population, typically of the size of that serviced by a substation.

The thermal regimes model may be extended to improve interpretability and incorporate physical constraints. Also, methodologies and algorithms may be developed for using characterizations of customer consumption patterns arising from this model in optimization of interventions for Demand-Response.

The model allows the most detailed description to date of individual energy consumption in a way that accounts for the large degree of volatility seen empirically in residential use.

The model has the formulation of a decision process, which allows a direct interpretation of choices of using HVAC (cooling or heating) or no HVAC. The methodology allows building profiles of occupancy as reflected in the magnitude, variance, and dynamics of the consumption process. It has low computational cost, yet high expression power for volatile residential data. It allows derivation of rich benchmarks and metrics that quickly and parsimoniously describe complex features of the data such as thermal energy response rates. It allows for extensions to incorporate physical thermal and occupancy states of the premise.

In the context of thermal energy use decomposition, when temperature and other weather data is used as external covariates, the invention has applications for Demand-Response programs, determine to whom and when should the DR signal be dispatched based on a forecast of outside temperature.

If pricing data is used as external covariates, the methodology allows one to compute customer response to prices, effectively allowing the identification of periods of time of either high or low price elasticity. This enables guiding demand-response programs that focus on varying prices to affect consumption. For example, higher prices would be offered to those customers and a those times when it is predicted that the customers would respond to pricing signals, but not at times of predicted low elasticity.

In addition, by achieving a non-intrusive decomposition of the aggregate (whole-home) consumption into components that depend on certain external factors (such as temperature), the methodology allows one to compute future expected usage of the temperature-dependent part of consumption for current setting of the HVAC (thermostat setpoint), which can be communicated to the customer either interactively (real-time on-device) or through their on-line or off-line electricity bill. With a change in the setting of the thermostat, the expected usage will change accordingly (and estimated through the model), which can be communicated to the customer.

Embodiments of the control scheduling dispatching system use day-ahead thermal response forecasts obtained from the thermal profiling method for each customer and data on a set of external conditions, in particular electricity price and a 24-hour operational energy reduction target profile. For example, in a preferred embodiment the schedules are 24-hour control sequences of the setpoint setting on an HVAC system, specifically the number of degrees Fahrenheit that the setpoint temperature will be changed to from its typical setting for each hour of the day.

The control scheduling system computes optimal sequences of actions or controls, to be performed either automatically if an IP-addressable thermostat capable of two-way communications is installed at the customer's premise, or manually by the customer if the realization of the control is a Demand-Response request message delivered via telephone, email, or text message. The optimal controls schedules for each individual define a certain level of day-ahead energy reductions over the course of each hour of the day, such that the 24-hour reductions profile aggregated over the customer population best matches a desired reductions profile.

In an embodiment, the demand-response control scheduling framework ingests the thermal profiles computed for each residential customer into a quadratic programming (QP) methodology with linear constraints to compute optimal, individual thermostat setpoint change sequences over the course of 24 hours. This yields tailored control schedules for each individual customer that may be implemented either automatically if a “smart” thermostat is available, or communicated to each customer via electronic communication channels including phone, email, or text messaging.

In another embodiment, the scheduling algorithm utilizes a greedy strategy to pick from a small set of pre-determined control schedules to assign to each customer. This instantiation of the control scheduling method is more scalable suitable for large populations, as it computes a faster, approximate solution to the quadratic programming problem.

### BRIEF DESCRIPTION OF THE DRAWINGS

FIG. 1 is an overview of the flow of a thermal profiling method including HMM decoding, state interpretation, and benchmark computation, according to an embodiment of the invention.

FIG. 2A is a graph of energy vs temperature illustrating a fixed breakpoint model benchmark for whole-home reading with thermal and non-HVAC activity.

FIG. 2B is a graph of temperature response profile as a function of temperature illustrating the temperature response rate for the breakpoint model of FIG. 2A.

FIG. 3A is a graph of energy vs time illustrating thermal regimes of different base load levels (bar y-height), thermal response rates (arrow slope), and characteristic duration (bar width), according to an embodiment of the invention.

FIG. 3B is a state diagram illustrating a possible structure of state-switching process with associated interpretation: heating (H), cooling (C), non-HVAC (N), and bursty (B) consumption regimes, according to an embodiment of the invention.

FIG. 3C is a graphical model of a consumption process, according to an embodiment of the invention.

FIG. 4A is a comparison of ground truth observations to estimated thermal response for a breakpoint model and thermal regimes model using a graph of interquartile match vs hour of day, illustrating detection performance of significant HVAC activity, according to an embodiment of the invention.

FIG. 4B is a graph of cumulative thermal response vs number of customers selected illustrating cumulative response ranking, according to an embodiment of the invention.

FIGS. 5A-B are graphs of energy vs temperature illustrating temperature profiles and identified thermal regimes for two customers, respectively, according to an embodiment of the invention.

FIGS. 6A-D illustrate seasonal and time-of-day distribution of occupancy states for two real customers using a graph of count vs hour of day for summer (FIG. 6A) and winter (FIG. 6B) of a first customer and for summer (FIG. 6C) and winter (FIG. 6D) of a second customer, according to an embodiment of the invention.

FIGS. 7A-B illustrate the temperature-dependent thermal regime probability for two customers using graphs of probability vs temperature, according to an embodiment of the invention.

FIG. 7C illustrates distribution of thermal regimes using effective thermal response for the two customers in a graph of effective thermal response vs temperature for two users, where error bars show the effective variance, according to an embodiment of the invention.

FIGS. 8A-C illustrate model performance on a sample of 1,923 customers in four zipcodes near a city, where FIG. 8A shows a breakdown of model size using a bar chart of number of customers vs number of occupancy states, and FIGS. 8B-C illustrate the distribution of fit metrics R² (FIG. 8B) and MAPE (FIG. 8C) for in-sample and out-of-sample performance, according to an embodiment of the invention.

FIGS. 9A-D illustrate segmentation of occupancy states by magnitude/type (heating or cooling) and duration for four temperature levels (shown as contour density plots), where classes are formed according to the quartiles of the distributions, according to an embodiment of the invention.

FIGS. 10A-H illustrate maximum targeting effectiveness by effort (number of users enrolled) for four levels of temperature, showing the total benefit (FIGS. 10A-D) and marginal benefit (FIGS. 10E-H) using graphs of averted energy consumption vs number of users, according to an embodiment of the invention.

FIG. 11 is a schematic diagram illustrating a system implementing a method according to an embodiment of the invention.

FIGS. 12A-C are graphs illustrating example input data to the analytic engine for the control schedules framework: day-ahead temperature profile T(t) (FIG. 12A), day-ahead reductions goal profile g(t) (FIG. 12B), and day-ahead electricity spot price q(t) (FIG. 12C), according to an embodiment of the invention.

FIG. 13 is a graph of a simple step effort profile structure, according to an embodiment of the invention.

FIGS. 14A-B are graphs of energy reductions vs time of day illustrating aggregate thermal energy savings obtained by running Algorithm 1 on the data set of 1,923 customers in Bakersfield, Calif., according to an embodiment of the invention.

FIGS. 15A-C are example graphs of requested effort vs hour of day illustrating tailored control schedules for three real customers in the Bakersfield, Calif. data set, according to an embodiment of the invention.

FIGS. 15D-F are example graphs of requested effort vs hour of day illustrating exact control schedules for three customers in a data set, according to an embodiment of the invention.

FIGS. 16A-B are graphs of expected cost vs effort budget illustrating estimated operational characteristics of a demand-response program performed over the target population of 1,923 PG&E customers in Bakersfield, Calif., according to an embodiment of the invention.

### DETAILED DESCRIPTION

The techniques of the present invention are motivated by certain types of Demand-Response (DR) designed to reduce loads associated with heating or cooling of a residential premise. Air conditioning and space heating are good targets for tailored DR events, since 1) they make up for a sizable component of electricity use in the U.S. (around 25% of total electricity consumption), and 2) are generally deferrable in time, since the thermal mass of the premise may act as “thermal battery”. Affecting the thermally-sensitive load may be typically achieved through direct load control of the HVAC system (e.g., load curtailment or automatic adjustment of the thermostat setpoint), through adjustable rates (e.g., critical peak pricing), or through incentive schemes. Therefore, it is of interest to understand how much of the energy consumed by each residential customer may be attributed to the operation of temperature-sensitive appliances, and how much is determined by other activities.

Embodiments of the invention provide a model that decomposes individual residential consumption into a thermal-sensitive part and a base load (non thermally-sensitive part). The model is based on thermal regimes, i.e., unobserved decisions of customers to use their heating or cooling appliances, in combination with other, non-thermal usage activity. These “thermal regimes” are the recurring states in consumption of a given household whose time sequence and base (non-thermal) loads depend on lifestyle (work schedule, occupancy etc.), whereas the state-specific temperature response (defined as rate of thermal energy consumption change with outside temperature) is associated with premise characteristics (thermal mass) and appliance characteristics (power drawn by HVAC appliances). It is a daunting task to disentangle the operation state of each appliance at a given time (which is the task of a related research direction, Non-Intrusive Appliance Monitoring), especially since obtaining ground-truth information on individual appliance consumption and on premise and customer characteristics is intrusive and expensive. But such detailed information might not even be required to design effective DR programs and tailored targeting strategies, where typically only a comparison between individual customers is sought. As such, given smart meter and weather data for a given premise, the techniques of the present invention are able to i) estimate an average thermal response of the premise and ii) characterize the probability that for a perceived temperature, the premise will be, in effect, either heating, cooling, or not using HVAC at all.

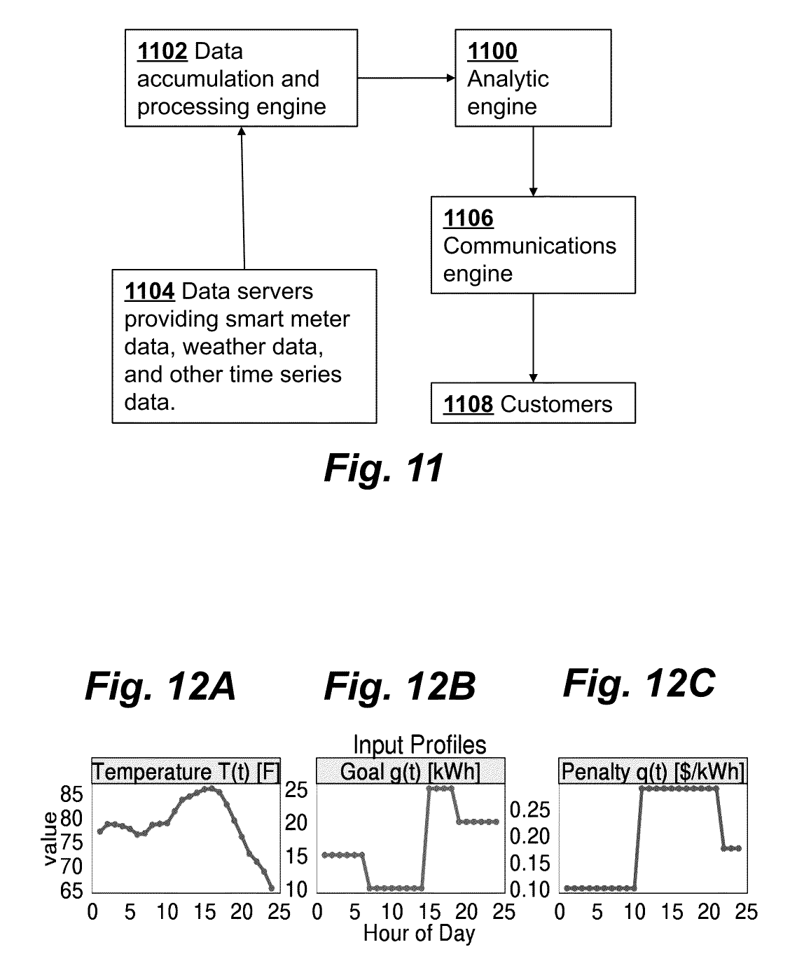

As shown in FIG. 11, embodiments of the invention may be realized as a computational platform comprising 1) analytic engine 1100 located either locally on utility-owned servers or in a cloud-computing service (for example, Amazon Web Services, Google Cloud Platform, or Microsoft Azure), 2) a data accumulation and processing engine 1102 that ingests and appropriately formats smart meter, weather, and other time series data from data server(s) 1104, and 3) a communications engine 1106 for dispatching control signals and requests to the appropriate individual customers 1108, as per the computations done by the analytic platform 1100.

The data accumulation and processing engine 1102 may be implemented as a software package running on the computational platform, and may be written either in a high-level programming language such as C/C++, or in a computational language such as Python, Matlab, or R. It is configured to receive raw smart meter data from the utility company. Second, it also ingests weather data from aggregation services and sources including, but not limited to, the NOAA weather service, Weather Underground, or Weather Analytics. Third, the data accumulation engine also ingests relevant time series data including, but not limited to, electricity prices, daylight times, and energy generation data from the appropriate sources such as the California Independent System Operator (CAISO), National Renewable Energy Laboratory (NREL) and others. The data accumulation and processing engine cleans, formats, and prepares the relevant data for analysis. The analyses performed by the data processing engine may include, but are not limited to, data gap analysis and filling (e.g., via interpolation, when appropriate), data cleansing and imputation of missing values (e.g., via regression analysis and interpolation), data resampling and aggregation, among others.

The analytic engine 1100 may be implemented in our example embodiment of this invention as a software system running on the computational platform. The software may be written in any modern language (for example, C/C++, Python, R). The analytic engine is configured to receive the results of the data processing done by the data accumulation platform. It then 1) computes thermal profile models as described below based on the data inputs, and 2) uses the results of the thermal profile model for specific applications related to demand-side management programs, including but not limited to computing optimal controls and actions at the individual customer level for thermal demand-response.

The communications engine 1106 is configured to receive the controls information from the analytic engine and to ensure appropriate dispatching of the signals, which typically amounts to informing the utility company of what the required controls are, if any, for each customer in the target population.

Problem Statement

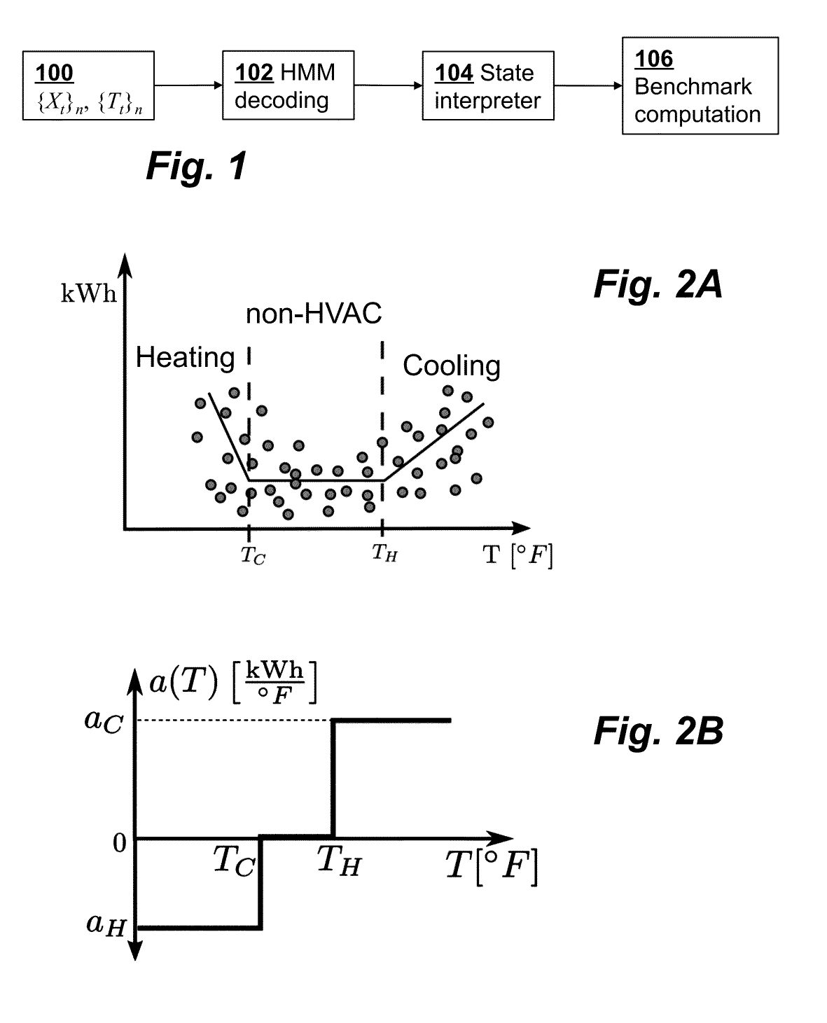

A high-level schematic of a thermal profiling methodology according to an embodiment of the invention is shown in FIG. 1 and described below. Data inputs 100 to the data processing engine are observed hourly-sampled energy consumption time series (measured in kWh) {xₜ}ₙ and outside temperature time series {Tₜ}ₙ for premises (customers) n=1, . . . , N. The data processing engine formats and cleans the data, and prepares it for analysis using the analytic computation engine. For each individual customer, the analytic computational engine performs the following steps to structure the smart meter observations (the subscript n is dropped in the following since we refer to only one given customer).

State decoding 102. In this step, the signal {xₜ} for a given customer is separated into time-consistent thermal regimes that have markedly different responses rates to temperature. In effect, the observations in {xₜ} are clustered according to how they change over time with changes in {Tₜ} into states S≡{s₁, . . . , s_{K}}. Each state kεS is characterized by a base load bₖ, a variance σₖ², and a temperature response rate a (measured in kWh). The response rates aₖ will be different at different levels of temperature T, i.e., for T>T′, with |aₖ(T)|>|aₖ(T′)| (in the case of heating). As a result of this step, the original consumption time series {xₜ} is decoded into the most likely sequence of thermal regimes {sₜ} from which each observation most likely originated.

State interpretation 104. From the decoded thermal regime sequence {sₜ} this step computes the time series of most likely thermal response {aₜ} and of base loads {bₜ}, and of variance of consumption {σₜ²}. The thermal response sequence is then used to classify each state according to the magnitude and sign of {aₜ}. Also, {σₜ²} may be used to infer the occupancy level, since when (multiple) customers are at home consumption will be more erratic; therefore, the identified regimes may alternatively be denoted as “occupancy states”. Note that occupancy may be sensed directly using motion sensors (as done in commercial buildings). However, such instrumentation is not widespread in the residential setting, and may be intrusive to install, as well as raise serious privacy concerns.

Benchmark computation 106. Several benchmarks are developed to characterize household consumption: the temperature-dependent duration of heating/cooling spells, the likelihood of heating/cooling at a given temperature level, and the effective temperature response.

Modeling Thermal Occupancy Regimes

Currently a popular framework in modeling the temperature response of residential premise energy consumption is the so-called “breakpoint model”. We briefly review this model here as it informs the discussion on the methodology developed in this invention. The model assumes a set of M i.i.d energy readings xₜ, t=1, . . . , M, that depend linearly with (outdoors) temperature Tₜ

xₜ=β₀+β₋(Tₜ−T_{C})₋+β₊(Tₜ−T_{H})₊+εₜ, (1)

where εₜ˜N (0, σ²), (z)₊≡max(z, 0) and (z)₋≡min(z,0) for an arbitrary real value z. Here β₀ is a temperature-insensitive base load. For Tₜ<T_{C} (T_{C} is the “cold setpoint”), the premise will use the heating appliance (resulting in a negative response of consumption with temperature); for Tₜε[T_{C}, T_{H}] (T_{H} is a “hot setpoint”) the premise will not use HVAC appliances (zero temperature response); and for Tₜ>T_{H} the premise will use the AC (with a positive response rate to temperature). Schematically, this model is presented in FIG. 2A. FIG. 2B illustrates the temperature dependency of the temperature response rate implied by the model, i.e., a piecewise constant profile with three response regimes (a_{C}<0, 0, and a_{H}>0). While informative for premises operating on strict HVAC schedules, this model fails to account for the large volatility observed in the hourly smart meter data. For example, comfort levels (determined by the indoors temperature) differ across customers; thus, customers may choose to dynamically change the thermostat settings T_{C} and T_{H} (for cooling) as a response to the perceived temperature T. Moreover, HVAC use is correlated with other activities when customers are at home or not; these, in turn, we assume consistent over time as to reflect daily customer routines.

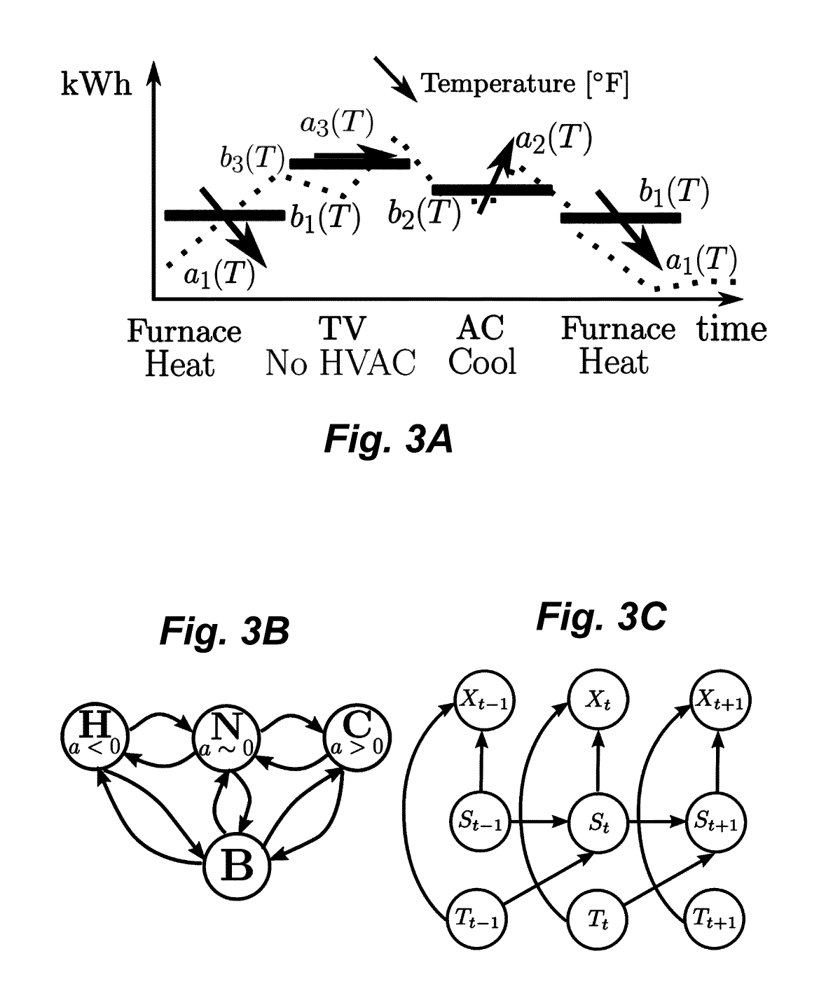

The intuition behind the thermal regimes model of the present invention is illustrated in FIG. 3A. At any given point in time, a customer may be using the furnace (for heating), the AC (for cooling), or not using HVAC at all. These are customer decisions that may depend on premise occupancy (i.e., whether they are at home or not) and on whether the thermal appliances run on a pre-determined schedule (which, in turn, the customer might change in time). However, such customer decisions and preferences are unobserved to the utility; what the utility does observe is the outcome of the decisions, i.e., the meter data (shown in the figure as dotted lines). As such, the thermal regimes model has two main components: i) a state-specific consumption response to temperature, and ii) a decision process that governs how the customer switches between states.

State-Specific Consumption

An individual premise is modeled as a state machine consuming energy in either of K (unobserved) states S={s₁, . . . , s_{K}}. At time t, when recorded outside temperature is Tₜ, and if the premise is in a given state k, consumption xₜ is assumed to be described by

(xₜ|sₜ=k,Tₜ)−N(bₖ+aₖ(Tₜ−T₀),σₖ²), (2)

where N(•,•) denotes a standard Gaussian distribution, and βₖ=(aₖ, bₖ, σₖ²) are parameters to be estimated. Here T₀ represents a typical value (e.g., T₀=65° F.) of the temperature level used in practice above which customers are expected to use cooling, and below which they are expected to use heating. This value may be fixed or learned separately from the data for each customer, e.g., by using the breakpoint model described above.

Here the state-specific (to state k) parameters aₖ and bₖ have a well-defined meaning for energy consumption. As such, bₖ is a base load for state k (consumption independent of temperature). Note that because the base load represents a physical energy quantity we have bₖ≧0. The aₖ parameter captures the rate of change in consumption with a change to the outside temperature. We distinguish three cases based on the magnitude and sign of aₖ:

1) aₖ>0: state k is a cooling state, since the higher the temperature, the more energy is consumed;

2) aₖ<0: state k is a heating state, since the lower the temperature, the more energy is consumed;
3) aₖ≈0: state k is a thermally-insensitive state.

Transition Decision Process

The physical process of consumption in response to temperature is generally influenced by both conscious decisions from the part of the customer (e.g., manually activating the thermostat or setting the AC setpoint), and by mechanistic response of automated systems (such as a fixed thermostat setpoint that activates heating). These effects are generally confounded and cannot be disentangled in the absence of additional information (such as recordings of customer interaction with the thermostat setting). In the absence of such data we make the assumption that given the current state i at time t, at time t+1 the customer chooses the next state jεS that maximizes a utility function that factors into his decision both the current thermal regime and the level of the outside temperature:

j=argmax{U_{i,k}|kεS} (3)

where utility is formulated as follows:

U_{i,j}(Tₜ)=c_{i,j}+d_{i,j}Tₜ+εᵢ. (4)

Here c_{i,j} models a temperature-independent base utility for transitioning from state i to state j, whereas d_{i,j} represents the contribution of a change of 1° F. in temperature to the utility. A state pair for which d_{i,j} is large and positive will be more heavily influenced by temperature in that transition process than for low values of d_{i,j}. Since these quantities are estimated from data for each customer, they will be quite different across a population.

Note that additional terms may be incorporated in such a formulation, e.g., real-time prices if that data is available; moreover c_{i,j} and d_{i,j} may easily be allowed to vary with each hour to incorporate the notion that customers might make different consumption decisions at different times of at different times in the day. However, for simplicity we choose the most basic formulation that illustrates the structure of the model.

We assume that the random term εᵢ follows an Extreme-Value (Gumbel) distribution. This assumption is typical in random utility theory since the Gumbel distribution approximates well a Gaussian distribution, yet is convenient to work with analytically as it allows a closed-form expression for the transition probabilities (leading to the so-called multinomial logit model):

P(Sₜ₊₁=j|Sₜ=i,Tₜ)=exp(c_{i,j}+d_{i,j}Tₜ)/Σₖexp(c_{k,j}+d_{k,j}Tₜ). (5)

Denoting {A(T)}_{i,j}≡P(Sₜ₊₁=j|Sₜ=i, Tₜ), the above defines an independent multinomial logistic regression model for each row of the temperature-dependent transition matrix A(T).

Above we made use of the (first order) Markov assumption that the state of the system at time t+1 only depends on its state at the current time step t, but not on all past history. However, the model as set up here can be easily extended to a higher Markov order (second, third, etc.), or to include other features of the observed data (e.g., average day-ahead consumption, maximum temperature, cumulative consumption the current day etc.) in either the transition process or the emission process. But this comes at a higher computational cost as the number of states needed to account for will increase more than linearly.

We denote by β=(a, b, c, d) the parameter vector that we need to estimate from data. From the Central Limit Theorem, β is distributed according to a multivariate Gaussian with a covariance matrix that may be computed as a by-product of the maximum likelihood estimation procedure below. This offers certain useful properties, e.g., to assess whether the response in any given state k is significantly different from 0, we may employ a standard hypothesis test such as the t-test.

A typical decision space is illustrated in FIG. 3B. There, the customer undergoes four possible thermal regimes: heating (H, a<0), cooling (C, a>0), non-HVAC (N, a˜0), and bursty (B). The bursty state exhibits fast dynamics (c_{B,B}=0) that does not have a strong temperature dependence (d_{B,j}=dj,B=0), which is suited to model the large consumption spikes due to occupant activity. A bursty consumption state may be entered from any of the other regimes; however the model may be adjusted (by setting the appropriate coefficients c and d to 0) so that the transition from cooling to heating happens only through a regime where no HVAC is used.

Model Estimation and Computational Aspects

The process described above is a hidden Markov model (HMM) for which both the emission and the transition distributions depend linearly on exogenously-given temperature. A graphical representation is given in FIG. 3C. As such, the likelihood under the model of an observed sequence xₜ may be written as:

$${L}_{T} ( x ; θ ) = P ( X = x ) = ΣP ( X = x , S = s ) = {δΠ}_{t = 1 , … , M} P ( {S}_{t} \vert {S}_{t - 1} ) P ( {X}_{t} \vert {S}_{t} , {T}_{t} ) , \qquad ( 6 )$$

where the sum is over s₁, s₂, . . . , s_{T}=1, . . . , K, and with δ=P(S₀) denoting the starting distribution of the Markov chain S, which we assume uniform for simplicity. By defining

P(xₜ,Tₜ)=diag(p₁(xₜ,Tₜ), . . . ,p_{K}(xₜ,Tₜ)), (7)

the likelihood in (6) may be re-written as:

L_{T}(x;θ)=δP(x₁,T₁)A(T₁) . . . P(x_{T},T_{M})A(T_{M}). (8)

Note that computing the likelihood as above may lead to numerical instability, since the repeated multiplication of small quantities (the probabilities) will result in numerical underflow. To address this issue we employ a re-scaling technique.

A typical estimation method for such models is the Baum-Welch algorithm, which is an Expectation Maximization (EM) type algorithm. However, the model formulation used in embodiments of the present invention includes constraints on the emission parameters bₖ (which have to be positive). This makes using EM cumbersome and less computationally efficient. Instead embodiments of the present invention use a direct likelihood maximization procedure:

θ*=max_{θ}L_{T}(x;θ) (9)

For a given customer, the quantity θ≡(aₖ,bₖ,σₖ²,cₖ,dₖ|k=1, . . . , K) is estimated by defining the likelihood as a non-linear function of θ and applying a numeric optimization algorithm. In contrast to the EM algorithm, which only results in point estimates of the parameters, this procedure allows to compute confidence intervals.

The analytic engine computes the most likely sequence of states {sₜ} that fits a given observation sequence {xₜ} (the decoding problem) using the standard Viterbi algorithm. This results in the recovery of the sequence of hidden decisions that gave rise to the observed consumption {xₜ}.

The number K of states (the model size) is generally not known in real applications. A suitable trade off between model complexity and expressive power may be found by selecting the simplest model (smallest K) that can account for at least R % out-of-sample variance. This may be done by adopting a simple selection strategy based on out-of-sample predictive performance of the model. Note that a standard k-fold cross-validation approach is not appropriate here because the random segmentation of the data will violate the serial correlation assumed by the Markov process. To overcome this issue, a deterministic 2-fold cross-validation approach may be used, as follows:

1) Start with a model of K=2;

2) Divide up the time series into an even and an odd sequence, and learn the model (2, 5) of a given K on the even sequence. The model parameters learned this way are the same as for the model learned on the full data, with the exception of the transition matrix of the half-chains being A² (where A is full chain matrix);

3) Compute out-of-sample decoding performance (using the Viterbi algorithm) of the even-chain model on the odd-chain model. The performance may be computed using variance explained (R²) or Mean Absolute Percentage Error (MAPE);

4) Set K→K+1, and repeat (2) and (3) until the out-of-sample performance reaches a desired R²≧85%.

The hard breakpoint in (1) is relaxed to allow different regimes to be triggered with different probabilities based on the outside temperature level. This more flexible model is better suited for the highly-volatile hourly residential consumption patterns observed in the real data, as well as accounts for the unobserved customer decisions that may change dynamically with time. For a premise in a thermal regime k and experiencing a temperature T, the probability that it will undergo a regime change may be computed according to (5), from which the most likely thermal regime at the next time step may be computed as follows:

max{A_{k,j}(T)|jεS} (10)

The long-run probability distribution π(T) of the premise being in either of the K regimes at temperature T may be computed using a result from Markov chain theory:

π(T)=π(T)A(T), (11)

from which π(T) may be obtained by finding the (normalized) 1-eigenvector of A(T). Note that this simplification essentially amounts to the response at each level of temperature being described by a mixture of normals, i.e.,

p(a(T))=Σₖπₖ(T)N(bₖ+aₖT,σₖ²). (12)

This distribution is then used to define an effective thermal response â(T)=Σₖ aₖπₖ(T) at a temperature level T.

Moreover, a result in the analysis of Markov chains may be used to define a mean time spent in state k:

τₖ=1/(1−A(T)ₖₖ), (13)

with A(T)ₖₖ the diagonal elements of the temperature-dependent Markov transition matrix. An effective thermal duration is then defined by \hat{τ}(T)=Στₖπₖ(T).

Data Description

Following is a discussion of the behavior of the model when estimated on real, high-frequency data for which ground truth HVAC readings were available. This is followed by a profile of the consumption of a large sample of real customers.

Ground-Truth Data

For an illustration of the model, a publicly-available, high-resolution (15 kHz) dataset (the Residential Energy Disaggregation Dataset, or REDD) is used. It contains readings from several individually-monitored appliances as well as whole-home circuits for several houses in Massachusetts and California. As an example, a premise (house_{—}13) is selected that had separate furnace readings and enough contiguous data aggregated at an hourly level (˜900 hours between Jan. 9-Feb. 21, 2012).

A second dataset used for an empirical validation of the framework was obtained from the Pecan Street experiment, which consists of more than 500 volunteer homes in Austin, Tex. and several neighboring cities. Each household is equipped with sensors that collect minute-level electricity use data both at the whole-home level and for 8 to 23 individually-monitored appliance circuits, amounting to around 90 million daily records. The present analysis further aggregates these into the general categories of thermal appliances (HVAC), base loads, and user-activated (e.g., toasters, TVs etc). It also used whole-home and individually-monitored consumption time series from 360 customers who had HVAC appliances.

Real Premise Data

Customer thermal profiling in a real-world context is illustrated by estimating the model on a large sample of 1,923 premises in a hot climate zone around Bakersfield, Calif. (zipcodes 93309, 93301, 93304, 93305). This sample data was obtained from the Pacific Gas and Electric Company. This is whole-premise data at an hourly level and spans one year from Aug. 30, 2010 to Jul. 31, 2011.

Weather Data

In each case, the appropriate weather time series (at the 5-digit zipcode level) data for each of the real premises used in the analysis was collected using an online API at wunderground.com.

The data (weather, ground truth appliance consumption, whole-home smart meter data) was appropriately cleaned, and formatted in the data processing engine before it was passed to the analytic engine responsible for learning the thermal regimes model.

Case Study: Individual Thermal Profiles

Validation Using the REDD Ground-Truth Data

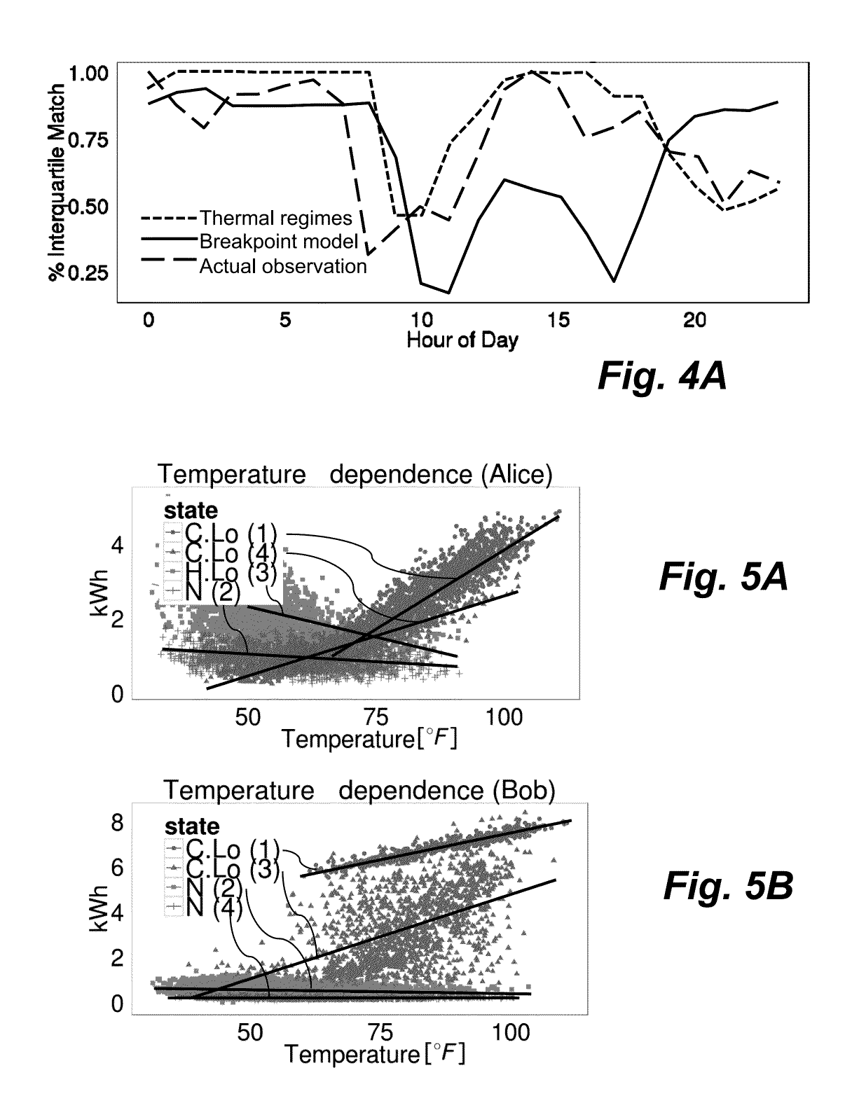

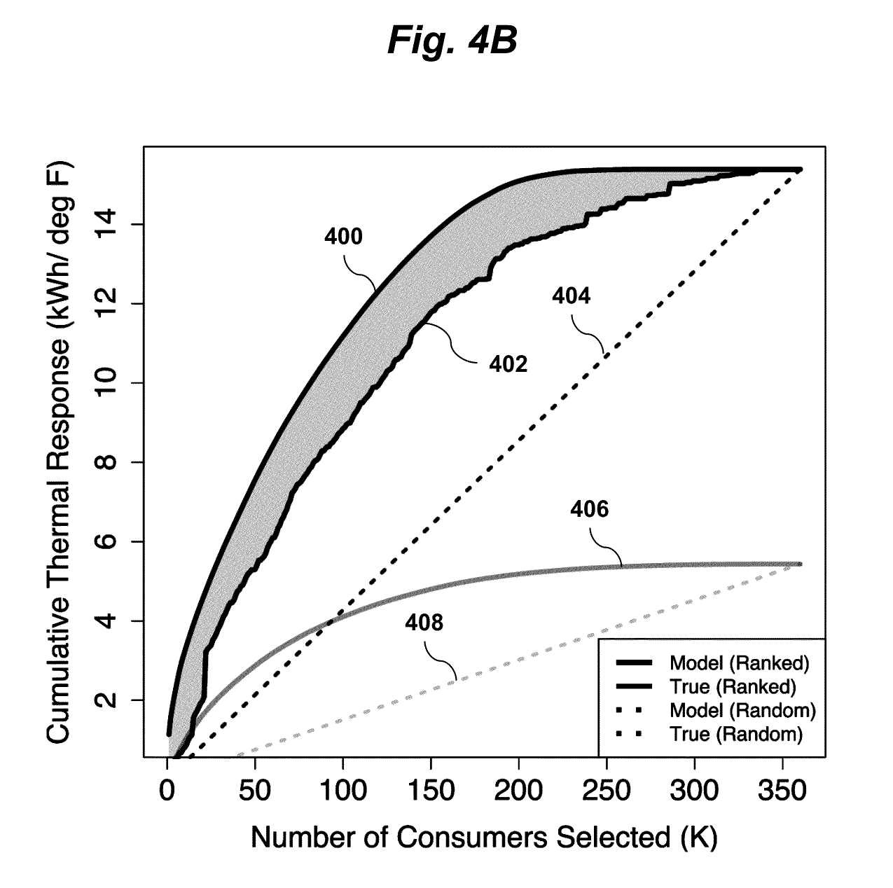

The analytic engine learned both the breakpoint (1) and the occupancy state models on the whole-home data for a test premise in the REDD data (house_{—}13). While this simple model will not, in general, offer accurate estimates of thermal energy consumption; yet it may serve to derive useful benchmarks about consumption across different premises for the purpose of comparison and classification. With this in mind, a comparison is made between the performance of the two models on detecting thermal activity in excess of a certain threshold (using the lower quartile of furnace energy consumption). That is, for each hour of the day, and for each of three detection methods (the thermal regimes model, the breakpoint model, and actual furnace consumption readings) the analytic engine computes the percentage over one year of times when the detected consumption activity was significant (defined as larger than a fourth of total household consumption for that time). The results are illustrated in FIG. 4A as percentage correct detections by hour-of-day. Used as a detector, the model identifies significant thermal activity more accurately on average than the simple breakpoint model (70% to 54%), and follows the ground truth furnace profile more closely.

Model Evaluation Using the Pecan St Ground-Truth Data

The 360 real premises in the Pecan St dataset were used to further validate the targeting methodology based on the benchmarks computed off the thermal regimes model. For this, a separate hidden Markov model is learned for each customer, as described above, using smart meter and temperature data. In particular, for a wide temperature range (1-120 F) an estimate is computed for the rate of change with temperature of the temperature-specific thermally-sensitive component of consumption for each customer. Then, at a given temperature level T, the customers are sorted in decreasing absolute value of their temperature response a(T). The temperature response is equivalent to an estimate of the amount of energy saved by changing the thermostat setpoint by 1 F, as required by a demand-response program. At the same time, the individually-monitored HVAC readings available for the Pecan St data are used to compute the “real” rate of change with temperature of the thermal response. The top curve 400 in FIG. 4B shows the “real” cumulative temperature response for increasing values of the number of K of customers selected for the thermal demand-response program, as obtained from separately-monitored HVAC data for a narrow temperature band around T=90 F (picked since at that temperature a premise is expected to use AC). The curve 406 near the bottom of FIG. 4B presents the cumulative average thermal response estimated using the thermal model for the same temperature range around T=90 F, whereby the individual consumers have first been ranked in decreasing order of their individual temperature response. Note that in absolute value there is a relatively large difference between the “real” response and the model estimates; however the model-estimated temperature response allows for a preservation of the “true” relative ranking of the customers by their ground truth thermal response. The lower curve 402 illustrates the real cumulative response (or, equivalently, energy reduction with a thermostat setpoint change of 1 F) when the customers are sorted according to the temperature response obtained from the thermal regimes model. The dashed line 404 corresponds to the “ground truth” cumulative response obtained when the customers are selected at random for the thermal demand-response program, with no regard to their thermal response values. Similarly, the dashed line 408 is the model-estimated cumulative response obtained when the customers are selected at random. Note that the curves 400 and 402 are relatively close: the relative errors of the cumulative reductions when sorting by model benchmarks are about 10-15% compared to the true cumulative response computed in the case when ground truth data is available.

Two Real Premises from Bakersfield, Calif.

In FIGS. 5A-B the temperature consumption profiles are shown for two customers in Bakersfield, Calif.: Alice (FIG. 5A) and Bob (FIG. 5B). Each point represents an hourly consumption reading. Alice has a temperature dependence that is similar to the heating-and-cooling profile in FIGS. 2A-B, while Bob primarily has cooling activity. The temperature profiles in FIGS. 5A-B are shown with corresponding thermal regime. Both customers' consumption may be explained using four thermally-dependent occupancy regimes to a cross-validation R²≧85%. For Alice, the model identifies two low cooling (C.Lo) states 1 and 4 for which a>0, one temperature-independent state 1, and one low heating (H.Lo) state 3. Note that in the case of Bob the model is able to identify a temporally-consistent low cooling state 2 (C.Lo) that would be otherwise masked by the high-variance cooling state 3 (C.Lo).

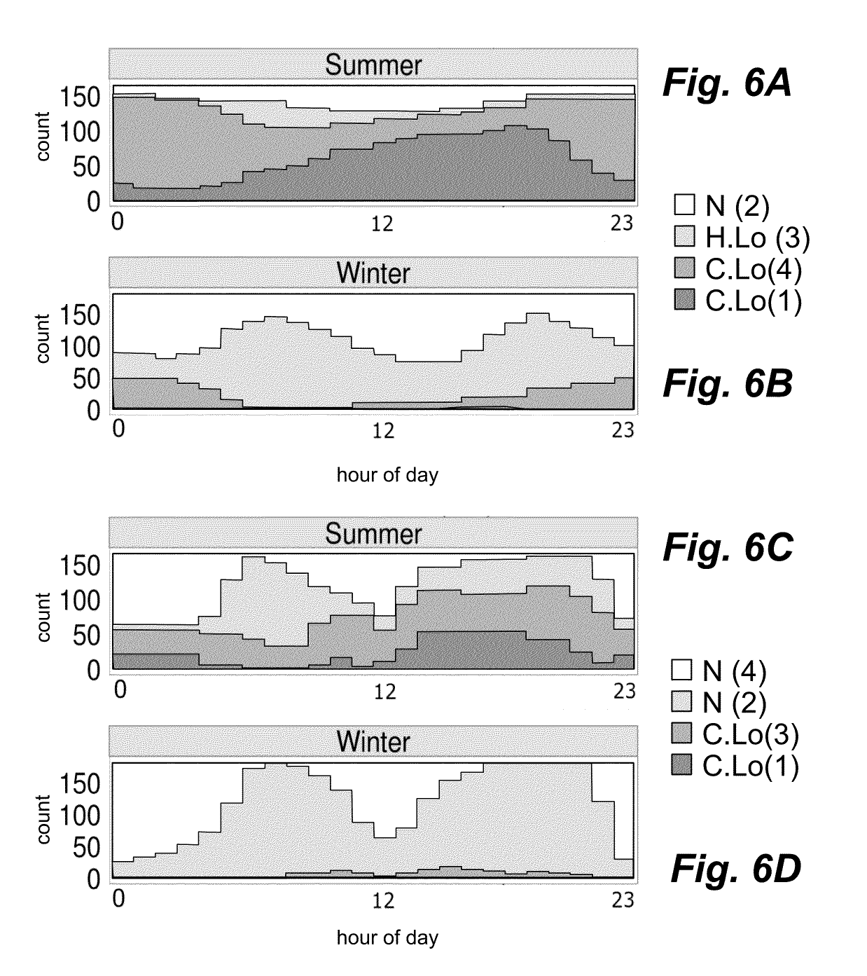

FIGS. 6A-D present the breakdown of thermal occupancy states for the two example customers by the summer and winter seasons (as defined by PG&E) and by hour-of-day. For Alice (FIGS. 6A-B) the strong cooling state 4 predominates during summer afternoon hours, while the low heating state 3 predominates during morning and evening hours in the winter; conversely the low cooling regime 1 predominates in summer afternoons. For Bob the low cooling state 2 is identified during summer afternoons; the highly-volatile low cooling state 3 also predominates during summer afternoons. In contrast, winters for Bob are spent in occupancy states that are relatively temperature-insensitive; this is understandable since the customer resides in a hot area (inland Central California). Note that the time-of-day distribution of the temperature-neutral state 4 for Bob is relatively stable over summer and winter; this is a regime of low occupancy and activity.

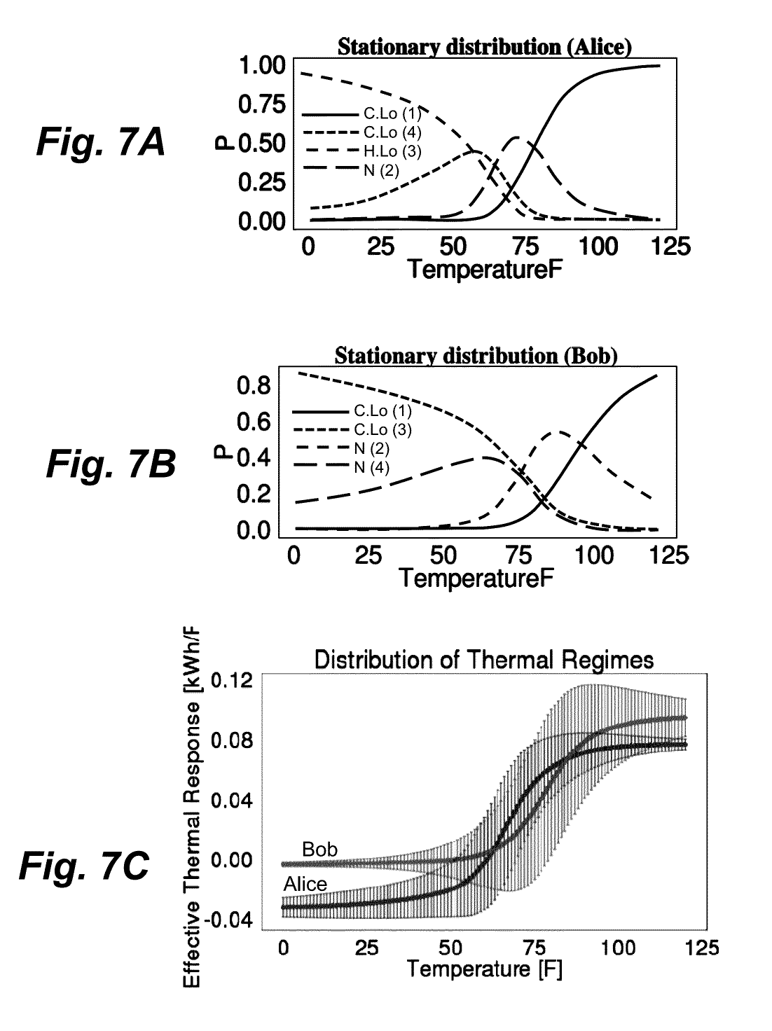

The analytic engine computes the benchmarks introduced above for the two customers, and present the temperature-dependent stationary probability distribution over thermal occupancy regimes in FIGS. 7A-C. For Alice (FIG. 7A) the probability distribution P(a(T)) captures the prevalence of the heating state 3 for low temperatures, the low cooling regime 1 for intermediate temperatures, and low cooling regime for intermediate and high temperatures higher than 75° F. Similarly, for Bob (FIG. 7B) the model identifies the temporally-consistent cooling state 2 as dominant for high temperatures (above 95° F.). In FIG. 7C the effective thermal response â(T) is shown for the two customers. Note that for both customers the transition between thermally-insensitive regimes and thermally-sensitive regimes happens gradually as temperature increases, in a relaxation of the typical profile obtained using the breakpoint model. The effective response profile may then be used as means to discriminate among customers to decide the best targets for tailored DR events.

Example Application: Thermal Segmentation and Targeting

Profiling a Customer Population

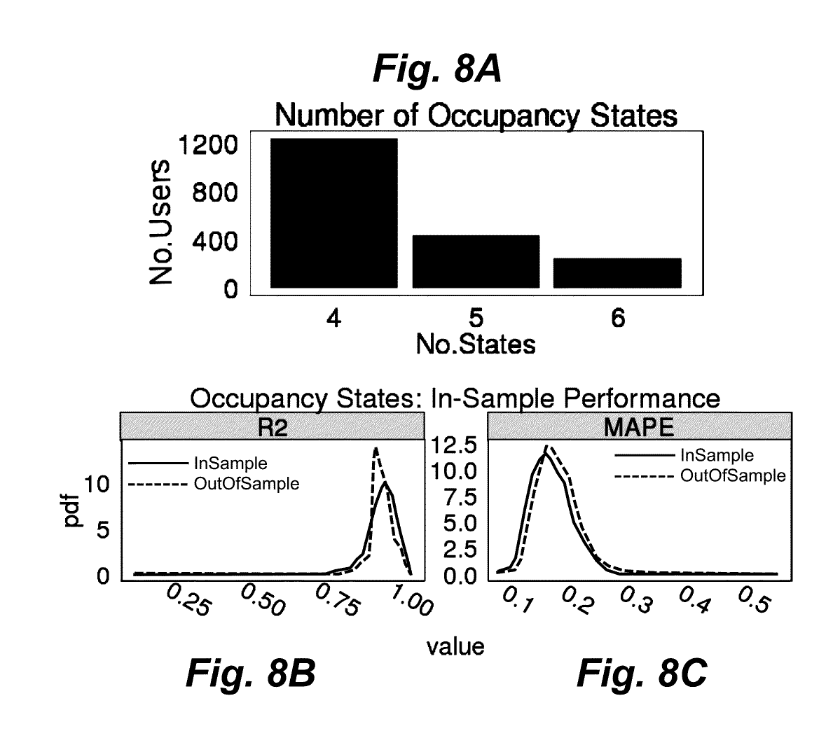

Individual occupancy state models were learned for each of 1,923 real households in the PG&E sample. Model performance results are presented in FIGS. 8A-C. For the large majority of the customers the model selection and cross-validation procedure determined that models with 4 states were needed to achieve at least 85% out-of-sample variance explained (R², see FIG. 8B). The states thus obtained for each customer (described by either 4-, 5-, or 6-state models) may be interpreted through the lens of the schematic in FIG. 3B as either Heating (H), Cooling (C), No-HVAC (N), or “Bursty” (B). Moreover, the fit performance is very good also on the MAPE fit metric (FIG. 8C). Here, out-of-sample cross-validation performance is reported by Viterbi-decoding the observations in the test set using the occupancy state model learned on the training set.

A Simple Segmentation and Targeting Scenario

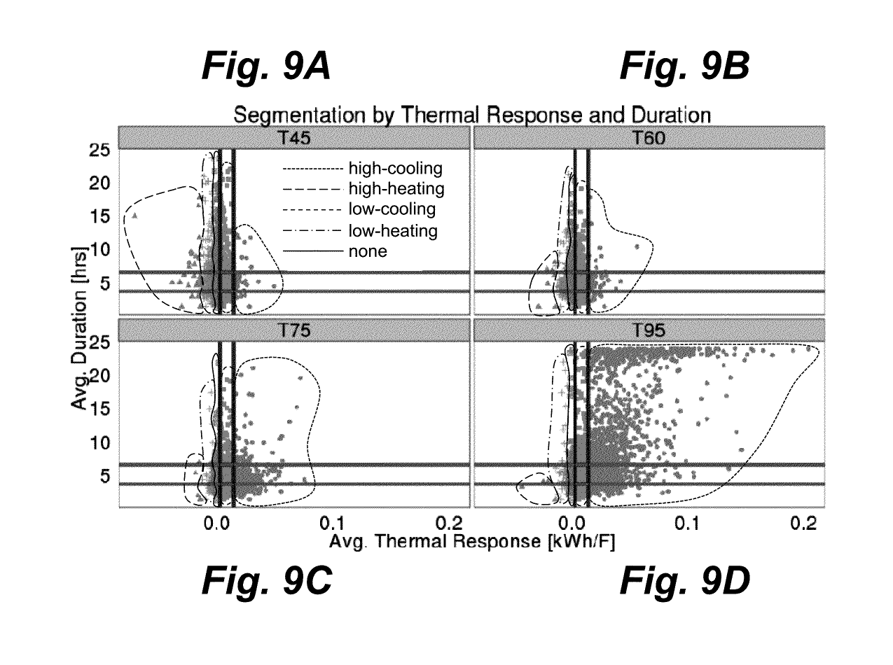

FIGS. 9A-D show a simple segmentation of customers in the sample by the effective thermal duration \hat{τ}(T) and the effective thermal response â(T) at four temperatures T=45 F, T=60 F, T=75 F, T=95 F, respectively. Customers are classified according to the corresponding quartiles across the population in which the customer's response falls under these two benchmarks. As such, one customer's effective thermal response may be either zero (very small response), low, or high heating or cooling (5 tiers total). Similarly, regime duration is classified into short, medium, and long.

Next consider the following scenario for customer selection in a Demand-Response program (e.g., the SmartAC program operated by PG&E in California). Suppose that for a given forecast on temperature levels next hour for which some amount of cooling activity is to be expected in the hot Bakersfield, Calif. area (Tε{45° F., 60° F., 75° F., 95 F}) the utility issues DR events asking customers to reduce their air conditioning level by 1° F. This action yields an averted energy consumption of â(T)×1° F. A selection problem is:

maxₓE[Σᵢxᵢa(T)] (14)

s.t.Σᵢxᵢ=N and xᵢε{0,1} (15)

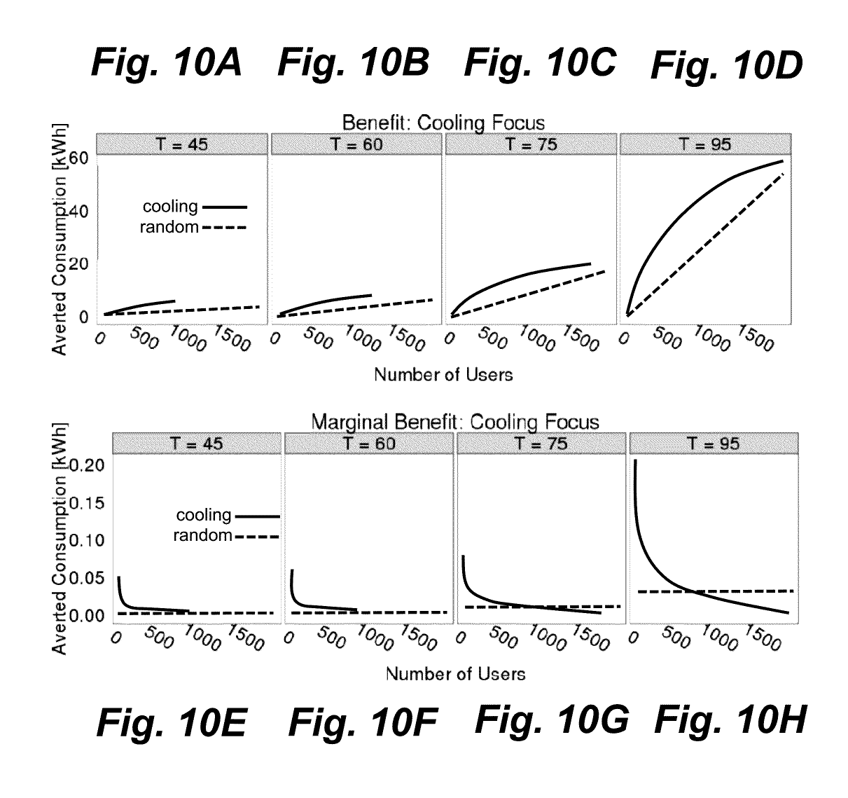

That is, the system operator wishes to select the subset of customers iε{1, . . . , N} (indicated by xᵢ=1) of a given size N such that the expected savings are maximized. Embodiments may implement at least two possible solutions to this problem for selected groups of customers of increasing size N: i) random selection (default) and ii) a greedy selection strategy that first ranks customers according to their effective cooling thermal response and selects the top subset. For this latter strategy only customers that displayed either a medium or high effective cooling behavior at the given temperature level T were used. The results of this exercise are shown in FIGS. 10A-H. Expected savings gained by taking into account the effective thermal response far exceed the default (random) numbers as clearly seen in FIGS. 10A-D. Moreover, the relative performance increases with temperature (since at high temperatures more customers turn their AC systems on and have stronger effective cooling responses). Savings per 1° F. of effort for a given customer subset size N for thermally-aware targeting exceed those of a random strategy by more than 100% for a hot hour (T=95° F.) and a moderate-size target population (N=500).

FIGS. 10E-H show the marginal benefit of enrolling additional customers in the program at different levels of temperature. Note the “transition point” (which is different at each of the temperature levels in the figure, e.g., N=500 for T=95° F.) after which the marginal benefit from the thermal DR scheme is lower than the random selection strategy. This is partly an effect of the sample size and averaging; about 2000 customers were in the analysis, so the mean response for subsets larger than a certain size will certainly be larger than the smaller responses. The marginal savings will naturally decrease, but what is surprising is that for groups larger than N˜100 the marginal average savings decrease more slowly. This can be interpreted as a “phase transition” in program impact; it reinforces the point that most cost-effective savings may be achieved by enrolling a small number of the right customers.

Note that it was assumed above that there is perfect customer compliance with requests for changing the thermostat setpoint, as well as no cost of control for the utility company. These are rather stringent limitations for realistic management of DR programs. However, the goal here is rather to illustrate the estimation of thermal response rates from data and exemplify a “best-case” scenario of computing the potential of a DR program. A greedy strategy may be modified to incorporate the cost of customer selection. Moreover, here the selection model is extended to allow for an “effort budget” for each customer that discourages selecting the same customers (likely the high-potential ones) all the time for control. In other embodiments, the cost of control or effort to the customer may be modeled by allowing a trade-off between monetary costs (real-time prices or incentives to take requested actions) and disutility to change in thermal comfort.

In conclusion, embodiments of the invention provide a methodology to construct dynamic energy consumption profiles for individual customers that is based on their response to outside temperature. Using this model several benchmarks may be computed for characterizing individual premises' consumption to be used segmentation and targeting for Demand-Response programs. The operator may ask customers to affect the setting on their heating or cooling appliances as to avert consumption during certain times (e.g., peak times or particularly hot days). The targeting strategy of the present invention is aware of the heterogeneity in thermal response and may achieve savings in excess of 100% of the performance of a random selection strategy.

Scheduling Thermostat Controls Based on Thermal Profiles

In one embodiment of this invention, the utility company may use the analytic engine to compute optimal control signals for the thermostat setpoint of each customer in a target population. By affecting the operation of the thermal appliance over a large population of customers, the utility may achieve flexible energy reductions at specific times of the day that shape aggregate demand as to match a desired day-ahead goal. As an example application, the flexibility thus extracted from the demand-side may be used to stabilize the variability in the generation profile due to local, distributed renewable generation.

The input information for this application is day-ahead forecasts of temperature for the next 24 hours for each customer in the sample, as well as operational information such as day-ahead electricity spot prices and day-ahead expected reductions goal. This data is used by the thermal regimes model to compute estimated thermal response profiles. Example input data—day-ahead temperature profile T(t), day-ahead reductions goal profile g(t), and day-ahead electricity spot price q(t) is displayed in FIGS. 12A, 12B, 12C, respectively.

Control Schedules

The utility operator issues requests for effort schedules uᵢ(t) to control the HVAC usage for certain customers i=1, . . . , N, with N the total number of customers. The quantity uᵢ(t) is the requested number of degrees (Fahrenheit) that the thermostat setpoint be modified at time t by customer i (see below). Note that a zero schedule uᵢ=(0, . . . , 0) is equivalent to not requesting participation from customer i.

As a result of the request uᵢ(t) the utility receives the energy reductions δᵢ=Aᵢuᵢ from user i at time t, where Aᵢ=diag(aᵢ), and aᵢ is the thermal response of customer i. Then the aggregate reductions profile is given by

$$Δ = {\sum }_{i = 1}^{N} {δ}_{i} .$$

The Market Setting

Moreover, the utility company operates in a market context where it incurs costs for failing to address the mismatch of demand and supply. These costs are typically the higher prices of electricity paid to the generators on the spot market. It is assumed that deviations from the goal profile g carry a time-varying penalty q (in $/kWh). FIG. 12C presents a possible structure of q(t) based on the time-of-use rate for PG&E in California.

The mismatch between the variability in demand and that in supply is an amount of energy that must be acquired (or sold on) the electricity markets. Here, the cost of purchasing additional generation is in general quadratic in the amount desired, as the marginal costs of generation increase approximately linearly with the generation needed. As such, the utility's cost may be expressed via a quadratic form.

$$E [ C ] \begin{matrix}= E [ {Δ}^{T} Q Δ ] - 2 {g}^{T} QE [ Δ ] + {g}^{T} Qg \\ = {u}^{T} E [ {A}^{T} Q A ] u - 2 {g}^{T} \overline{A} u + {g}^{T} Qg \\ = {u}^{T} Hu - 2 {h}^{T} u + c ,\end{matrix}$$

where Q=diag(q) and the matrix H is given by

$${H}_{i , j} = \{ \begin{matrix}{\overline{A}}_{i}^{2} Q + {QW}_{i} & if i = j \\ {\overline{A}}_{i}^{T} Q {\overline{A}}_{j} & if i \neq j\end{matrix}$$

At the same time, managing demand may be costly, so not every customer's usage can be economically adjusted at all times. Each customer may only be asked to take action (modify their HVAC consumption) up to a certain effort budget β that may be either constant or varying across customers (e.g., for PG&E's Smart AC program, an enrolled customer may be called upon at most 10 times during certain hot summer days and asked to reduce AC usage in return for lower year-round rates). The utility's task is to minimize the expected cost subject to budget and other constraints:

$${min}_{\{ {u}_{i} \}} E C ( {\{ {u}_{i} \}}_{i = 1}^{N} ) s . t . 0 \leq {u}_{i} \leq 1 , {∀}_{i} = 1 , … , N , {u}_{i}^{T} 1 \leq β , {∀}_{i} = 1 , … , N ,$$

Note that in the case where there is no budget constraint the objective function above is separable, and the minimization may be performed over each component separately. However, with the addition of the constraint, there appears a strategic trade-off between controlling at a given time (which incurs a certain cost and offers a payoff), or retaining the right to control for use at a later time.

In the simplest case it is assumed that the customer will comply fully with the requests for control. This is appropriate for the case of automated controls done via a smart thermostat that has a two-way communications channel. If this is not the case, but compliance depends, e.g., on occupancy (whether the customer is at home or not) or other unobservable factors, the effort schedule and the constraints in the optimization problem above become probabilistic; this case adds more realism to the problem setup and is the subject of future work.

Computing Exact Control Schedules

Algorithm 1 summarizes the practical implementation for solving the above optimization problem exactly. It relies on a quadratic programming (QP) formulation using the cost function and the constraints as detailed above. In a preferred embodiment of this invention it is implemented in the R programming language on the analytic engine.

Algorithm 1 Computing tailored individual schedules.

```
Require: Thermal response profiles {aᵢ}ᵢ₌₁^{N}; goal profile g;
  effort budget β.
Ensure: Effort schedules {uᵢ}ᵢ₌₁^{N}.
1) Compute H using Equation (13), h and c from Equation
  (12), and G using Equation (14).
2) Solve QP
    ${min}_{u} {u}^{T} Hu - 2 {h}^{T} u + c$
    s.t. Gu ≦ β
      0 ≦ u ≦ 1,
  using a high-performance solver, e.g., MOSEK via the
  Rmosek interface to the statistical computing language R.
```

The resulting aggregate thermal reduction obtained by running Algorithm 1 on the data set of 1,923 customers in Bakersfield, Calif. is presented in FIGS. 14A-B. The match between the aggregate reductions profile and the day-ahead goal profile for a small value of the effort budget β=1×5 F is shown in FIG. 14A. The same matching for a higher value of the effort budget β=3×5 F is shown in FIG. 14B. Note that for higher allowed effort flexibility the match is far better.

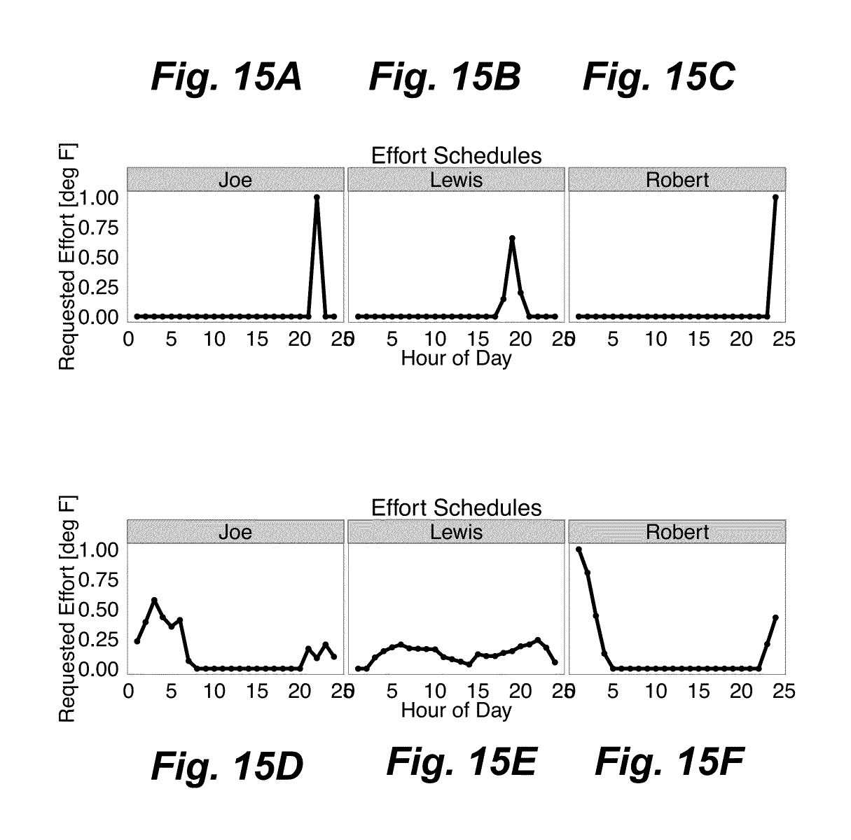

The analytic engine computes tailored control schedules for each customer in the data set. Example exact control schedules are presented in FIGS. 15A-F for three customers (arbitrarily named Lewis, Joe, and Robert). These are the optimal sequences of thermostat setpoint changes over a day for each of the three customers that both satisfy the effort budget constraints and contribute to an optimal aggregate reductions outcome. FIGS. 15A-C show control schedules for the three customers when the effort budget is small β=1×5 F; FIGS. 15D-F shown the optimal control schedules for the same customers in the case when β=3×5 F. Note that when more flexibility is allowed in control, the effort is more spread-out throughout the day.

Computing Fast, Approximate Schedules

Computing tailored control schedules for each individual customer may have certain downsides:
tweaking consumption in a tailored way for many thousands of customers may lead to an actual increase in volatility on the grid and may adversely affect grid stability;
managing thousands of control schedules may be prohibitively complex operationally;
reliably estimating NT control parameters carries high computational and data requirements for large N.

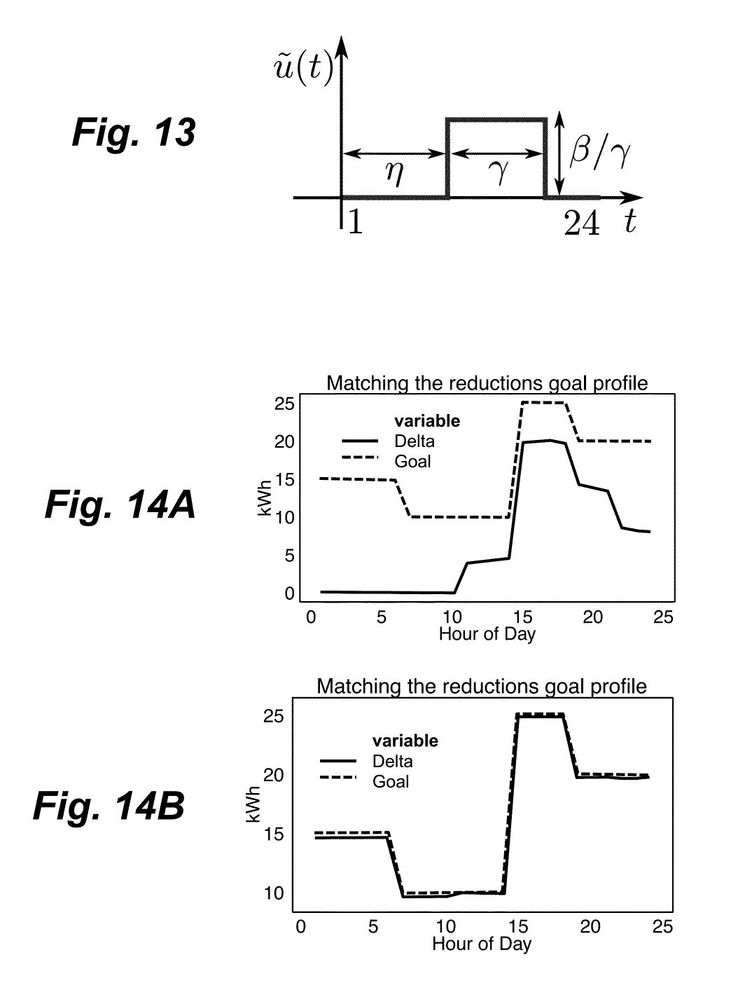

Thus, embodiments may consider the scenario where each customer may only receive (or choose from) a small set of types of schedules. These schedules may be specified in a contract or in a marketing campaign, in which case they should be simple to convey to the customer (e.g., “turn up the thermostat setpoint by 3 F after 4 pm”). The set of schedules available to customer i is denoted by Uᵢ, and it is allowed to include both the “null” schedule 0=(0, . . . , 0) that encodes not selecting user i at all, and simple step effort profile structures as described in FIG. 13. For a fixed value of the control effort budget β, these step functions are fully determined by two parameters and γ and η. These parameters represent, in turn, the duration of the control and the time of start of the control.

The scheduling problem may then be written as one of selecting a subset Aᵢ of customers, and for each customer e in Aᵢ a corresponding schedule such that a match is achieved between the variability in demand and that in supply:

$${min}_{} E C ( ) . s . t . ≡ \{ {\tilde{u}}_{e} ∈ {e}_{} \vert e ∈ \}$$

This is a discrete optimization of a submodular function. Define Y=U_{{i=1}}^{N}Uᵢ. To optimize this function, the analytic engine implements Algorithm 2, which this invention has developed for this purpose.

Algorithm 2 Greedy algorithm for maximizing non-monotone
submodular functions.

```
Require: set Ω = {aᵢ}ᵢ₌₁^{N}; Sets [symbol] ᵢ, i = 1, . . . , N of potential
  effort schedules; parameter ε.
Ensure: selected consumer set [symbol]     with the associated effort
  schedule set [symbol]   .
  Initialize
1) e, ũₑ := [symbol]    f ( [symbol]   );
2) [symbol]   := {e}, [symbol]    := {ũₑ}, [symbol]  ′ := [symbol]   \ [symbol]  ₑ.
  Repeat
1) Step forward: Find an element e ε Ω \ [symbol]   and ũₑ ε [symbol]  ′ for
  which
    $f ( ⋃ {\tilde{u}}_{e} ) > ( 1 + \frac{ɛ}{{n}^{2}} ) f ( )$
  If e ≠ :
• let [symbol]   := [symbol]   ∪{e}, [symbol]   := [symbol]   ∪ {ũₑ}, [symbol]  ′ := [symbol]  ′\ [symbol]  ₑ;
  Otherwise:
2) Step backwards: Find an element e ε [symbol]   and ũₑ ε [symbol]   for
  which
    $f ( \backslash {\tilde{u}}_{e} ) > ( 1 + \frac{ɛ}{{n}^{2}} ) f ( )$
  If e ≠ :
• [symbol]   := [symbol]   \{e}, [symbol]   := [symbol]   \{ũₑ}, and [symbol]   ′ := [symbol]  ′ ∪ [symbol]  ₑ;
  Otherwise: terminate.
  until terminate or [symbol]   ′ = .
```

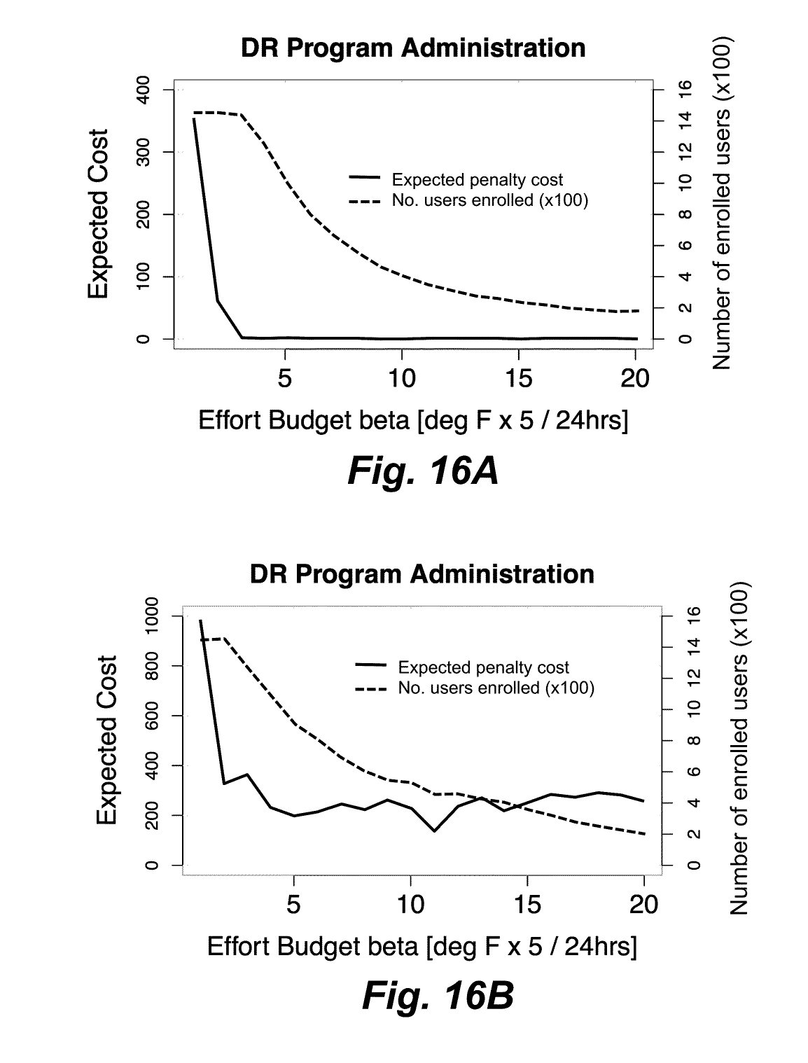

FIGS. 16A-B present the estimated operational characteristics of a demand-response program performed over the target population of 1,923 PG&E customers in Bakersfield, Calif. The program affects the setpoint of the thermal appliance of selected customers up to a specified effort budget throughout a 24-hour day-ahead horizon. This control may be implemented either automatically if a “smart” thermostat is available, or via direct communication with the customer using email, phone, or text messaging channels. The analysis presents the number of customers needed to enroll in the demand-response program (the red line on the figure) as a function of the maximum allowed effort budget β. The expected cost of mismatch between the aggregate reductions and the goal profile is also presented as the blue line. The top panel in the figure presents this analysis for the case when exact schedules are computed, whereas the bottom panel presents the analysis for the case when approximate schedules are computed. Note that when individually-tailored schedules are allowed, and the effort budget is relatively large, the number of customers needed to reach the reductions goal profile is a relatively small fraction of the total population; conversely with small effort budgets (which correspond to only limited flexibility requested from the customers) and with fixed, approximate schedules, the number of customers needed for the demand response program increases, and the cost of mismatch becomes larger as well.

1. A computer-implemented method for utility energy demand-response management using thermal profiling, the method comprising:
collecting and processing time-series data associated with a utility customer, where the time-series data has hourly or sub-hourly time resolution and comprises electrical consumption data and weather data comprising outside temperature data;
computing from the time-series data associated with the utility customer a thermal regimes model that describes consumption as based on implicit temperature-dependent decisions to heat, cool, or neither heat nor cool, wherein the thermal regimes model is formulated as a non-homogeneous hidden-Markov process having thermal regime states and state transitions between the thermal regime states, where each thermal regime state comprises a temperature-independent base load and a temperature dependent thermal response load;
dispatching demand-response program signals to the utility customer based on the thermal regimes model and forecast weather comprising outside temperature forecast.

2. The method of claim 1
wherein the weather data comprises pressure, humidity, and solar irradiance data; wherein the thermal regimes model is computed additionally from the pressure, humidity, and solar irradiance data; and wherein the demand-response program signals are dispatched additionally based on forecast pressure, forecast humidity, and forecast solar irradiance.

3. The method of claim 1
wherein the time-series data further comprises electricity prices, interaction with the utility customer, time-of-day, and day-of-week information; and wherein dispatching demand-response program signals is additionally based on forecast electricity pricing and customer interaction data.

4. The method of claim 1
wherein dispatching demand-response program signals to the utility customer comprises ranking customers in a decreasing order of estimated temperature response at a given hour within a forecasting horizon based on thermal regimes models of the customers.

5. The method of claim 1
wherein dispatching demand-response program signals to the utility customer comprises selecting customers likely to be at home, depending on operational characteristics of a predetermined demand-response program.

6. The method of claim 1
wherein dispatching demand-response program signals to the utility customer comprises computing control schedules for changing the setpoint of the thermal appliance based on operational and financial constraints and goals of the utility

7. The method of claim 1
wherein the control signals may be tailored to each selected individual customer in a target population or optimally selected for each individual customer from a small, fixed set of pre-determined schedules.
